(19) United States
(12) Patent Application Publication
(10) Pub. No.: US 2017/0057310 A1
(43) Pub. Date: Mar. 2, 2017

(54) TRAILER HITCH SPRING PIN LOCK MECHANISM

(71) Applicants: Chris Wayne Smith, Monroe, LA (US); Kenneth Lee Griffin, West Monreo, LA (US)

(72) Inventors: Chris Wayne Smith, Monroe, LA (US); Kenneth Lee Griffin, West Monreo, LA (US)

(21) Appl. No.: 14/839,000

(22) Filed: Aug. 28, 2015

(51) Int. Cl. B60D 1/28

(52) U.S. Cl. CPC B60D 1/28

(57) ABSTRACT

A trailer hitch spring pin lock mechanism is provided. The mechanism includes a hitch receiver secured to a trailer hitch main body. The trailer hitch main body may be secured to a chassis of a vehicle. The hitch receiver includes a side wall forming a hitch receiver slot within and a front opening leading into the hitch receiver slot. A side opening is formed through the side wall. The present invention further includes an outer plate having an outer plate opening formed there through. The present invention further includes a main pin. A protrusion 40 extends laterally from the main pin. The main pin runs through the outer plate opening and the side opening. A spring is secured around the main pin in between the protrusion and the outer plate, biasing the main pin within the hitch receiver slot.

### BACKGROUND OF THE INVENTION

The present invention relates to a trailer hitch and, more particularly, to a trailer hitch spring pin lock mechanism.

A tow hitch is a device attached to the chassis of a vehicle for towing. It can take the form of a tow ball to allow swiveling and articulation of a trailer, or a tow pin, or a tow hook with a trailer loop, often used for large or agricultural vehicles where slack in the pivot pin allows similar movements. Receiver-type hitches consist of a portion that mounts to the frame of the vehicle that has a rearward-facing opening that accepts removable ball mounts, hitch bike racks, cargo carriers, or other hitch mounted accessories. Pins and clips secure the mounts within the hitches. The pins and clips may be misplaced or lost.

As can be seen, there is a need for a pin secured to the receiver hitch.

### SUMMARY OF THE INVENTION

In one aspect of the present invention, a trailer hitch spring pin lock mechanism comprises: a hitch receiver comprising a side wall forming a hitch receiver slot within and a front opening leading into the hitch receiver slot, wherein a side opening is formed through the side wall; an outer plate comprising an outer plate opening; a main pin comprising a protrusion extending laterally from the main pin, wherein the main pin runs through the outer plate opening and the side opening; and a spring secured in between the protrusion and the outer plate and biasing the main pin within the hitch receiver slot.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention;

FIG. 2 is a perspective view of an embodiment of the present invention;

FIG. 3 is an exploded view of an embodiment of the present invention;

FIG. 4 is a perspective view of the present invention in a locked position prior to engaging with a hitch;

FIG. 5 is a perspective view of the present invention in an unlocked position prior to engaging with a hitch;

FIG. 6 is a perspective view of the present invention in an unlocked position while engaging with a hitch mechanism;

FIG. 7 is a perspective view of the present invention in a locked position engaged with a hitch;

FIG. 8 is a section detail view of the present invention along line 8-8 in FIG. 6;

FIG. 9 is a section detail view of the present invention along line 9-9 in FIG. 7; and

FIG. 10 is a section detail view of the present invention along line 10-10 in FIG. 2.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a trailer hitch that replaces the pin and clip system. The hitch of the present invention includes a spring loaded pin that secures the receiver to the hitch. The spring automatically locks the receiver in place. Further, since the pin is secured to the side the trailer hitch, the present invention prevents the pin from being misplaced and lost.

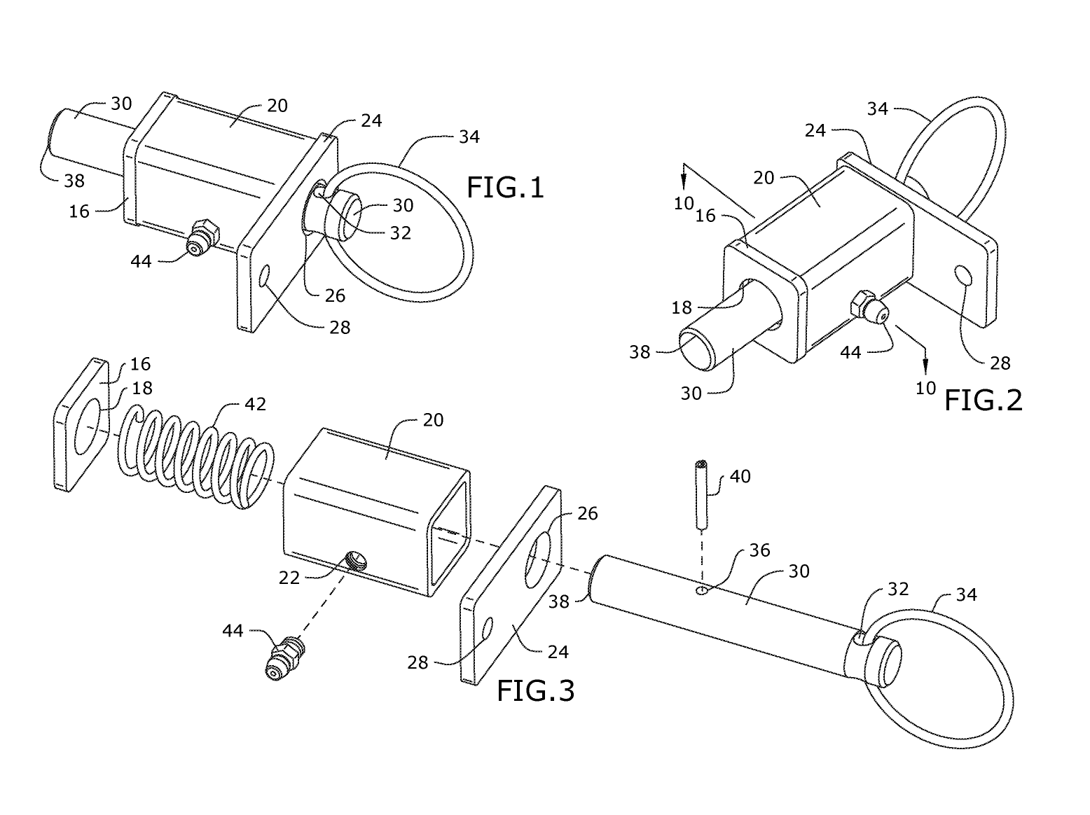

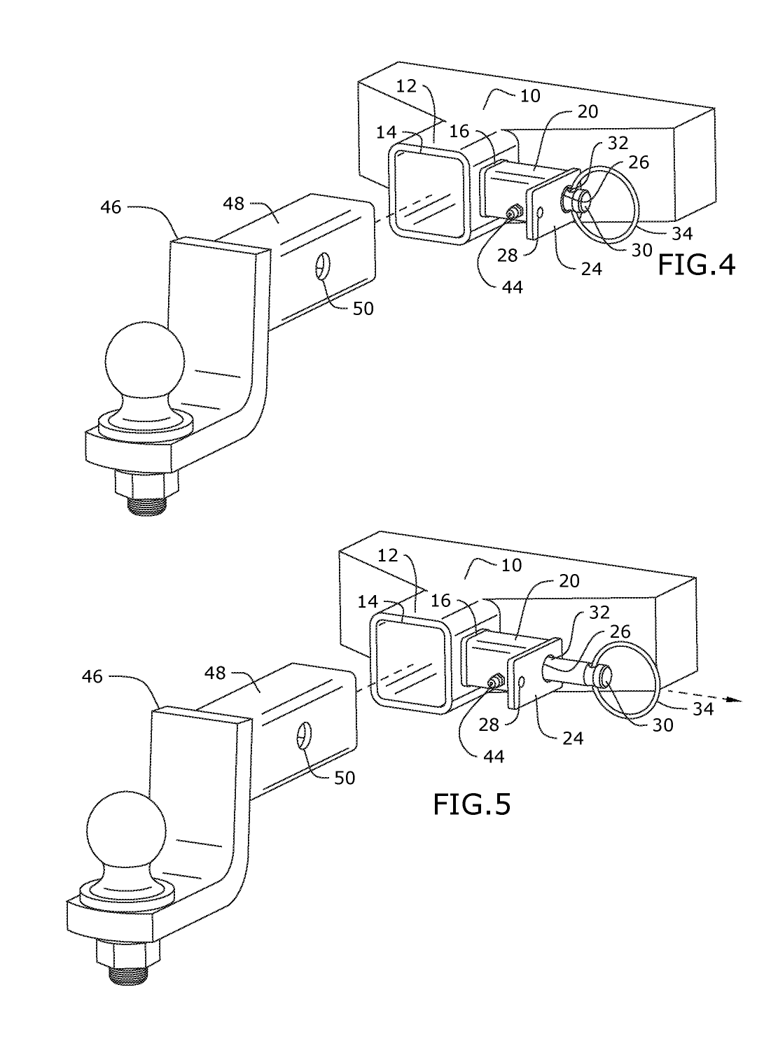

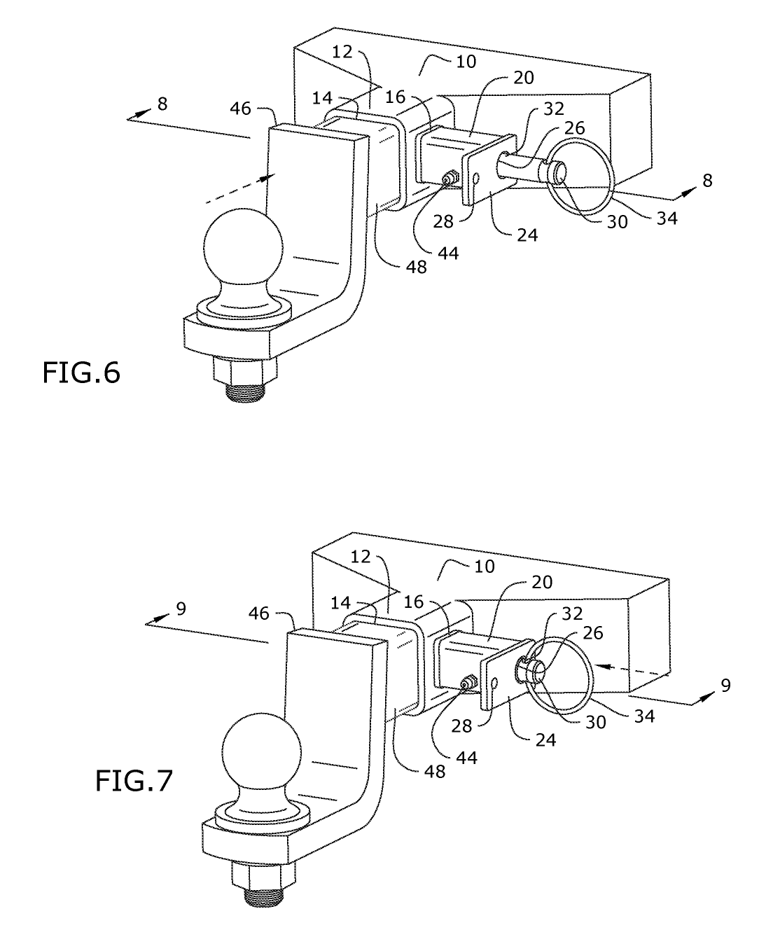

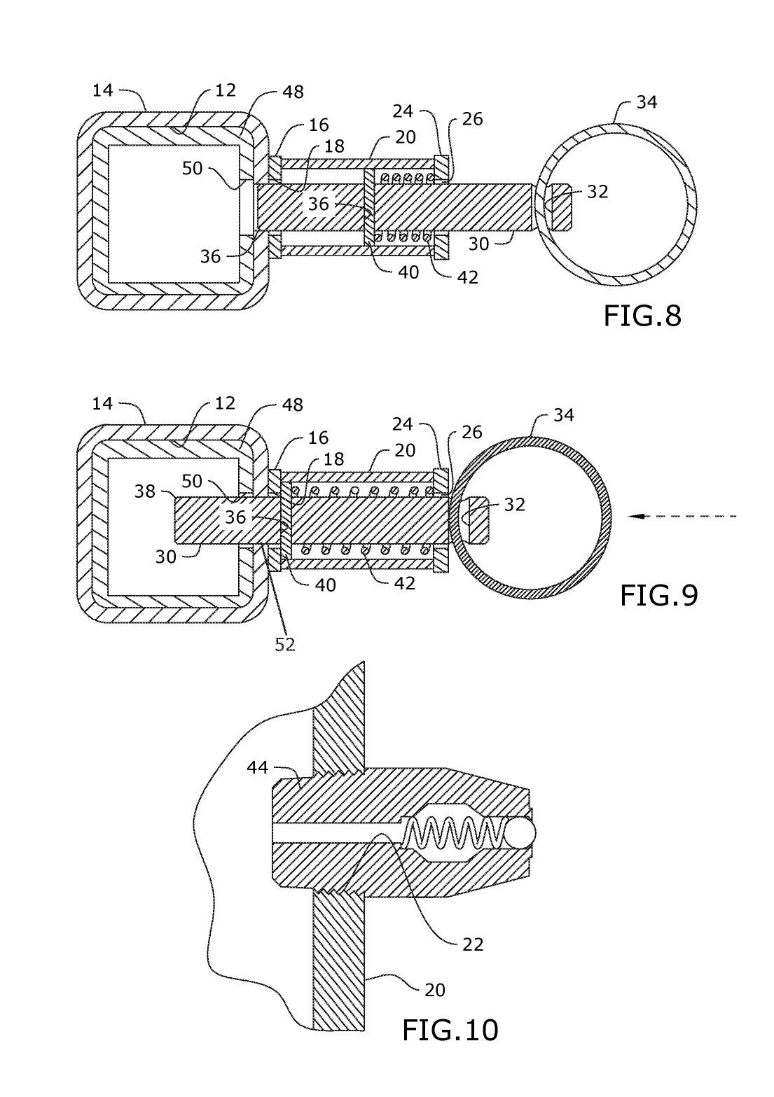

Referring to FIGS. 1 through 10, the present invention includes a trailer hitch spring pin lock mechanism. The mechanism includes a hitch receiver 12 secured to a trailer hitch main body 10. The trailer hitch main body 10 may be secured to a chassis of a vehicle. The hitch receiver 12 includes a side wall forming a hitch receiver slot 14 within and a front opening leading into the hitch receiver slot 14. A side opening 52 is formed through the side wall. The present invention further includes an outer plate 24 having an outer plate opening 26 formed there through. The present invention further includes a main pin 30. A protrusion 40 extends laterally from the main pin 30. The main pin 30 runs through the outer plate opening 26 and the side opening 52. The protrusion 40 is disposed in between the outer plate 24 and the side wall. A spring 42 is secured around the main pin 30 in between the protrusion 40 and the outer plate 24, biasing the main pin 30 within the hitch receiver slot.

The present invention may further include an end plate 16 fixed to the outer side wall. The end plate 16 includes an end plate opening 18 that aligns with the side opening 52. A housing 20 may connect the end plate 16 and the outer plate 24 together. The outer plate 24 may include a lock hole 28. The main pin 30, the protrusion 40 and the spring 42 may be disposed within the housing 20. The main pin 30 may run through the outer plate opening 26, the end plate opening 18, the side opening 52 and into the hitch receiver slot 14.

The present invention may further include a grease fitting 44. The grease fitting 44 may include a mail threaded portion. The housing 20 may include a threaded female aperture 22 formed to receive and secure the grease fitting 44 within. The grease fitting 44 screws into the threaded female aperture 22, thereby securing to the housing 20.

The main pin 30 includes an inner end and an outer end. The protrusion 40 extends in between the inner end and the outer end. In certain embodiments, the protrusion 40 may include a roll pin snuggly secured within an aperture 36 formed through the main pin 30. However, in certain embodiments, the protrusion 40 may include a flange extending from an outer surface of the main pin 30. The main pin 30 may further include a handle 32, 34 attached to the outer end of the main pin 30, beyond the outer plate 24. The handle 32, 34 may be formed by an aperture 32 formed through the outer end of the main pin and an O-ring 34 disposed within the aperture 32. The main pin 30 may also include a chamfer 38 formed on the inner end.

A method of using the present invention may include the following. A user may pull the O-ring 34, and thereby pull the main pin 30 out of the hitch receiver slot 14. The user may then slide a shaft tube 48 of a hitch mechanism 46 into the hitch receiver slot 14. A tube hole 50 of the shaft tube 48 aligns with the side opening 52 of the hitch receiver 12. The user may then release the O-ring 34. The spring 42 urges the main pin 30 through the side opening 52 and into the tube hole 50, thereby locking the hitch mechanism 46 in place. When removing the hitch mechanism 46, the user may again pull on the O-ring 34, and thereby pull the main pin 30 out of the tube hole 50. The user may then slide the shaft tube 48 out of the hitch receiver slot 14.

It should be understood, of course, that the foregoing relates to exemplary embodiments of the invention and that modifications may be made without departing from the spirit and scope of the invention as set forth in the following claims.

What is claimed is:

1. A trailer hitch spring pin lock mechanism comprising:
a trailer hitch main body securable to a chassis of a vehicle, wherein the trailer hitch main body comprises a hitch receiver integral with the trailer hitch main body and comprising a side wall forming a hitch receiver slot within and a front opening leading into the hitch receiver slot, wherein a side opening is formed through the side wall;
an end plate fixed to the outer side wall and comprising an end plate opening aligning with the side opening;
an outer plate comprising an outer plate opening;
a housing connecting the end plate and the outer plate together, wherein the housing is horizontally disposed relative to a hitch ball secured to the hitch receiver,
a main pin comprising a protrusion extending laterally from the main pin, wherein the main pin is disposed within the housing and runs through the outer plate opening, the end plate opening and the side opening; and
a spring disposed about the main pin and biasing the main pin within the hitch receiver slot.

2. (canceled)

3. (canceled)

4. The trailer hitch spring pin lock mechanism of claim 1, further comprising a grease fitting releasably secured within a threaded opening formed through the housing.

5. The trailer hitch spring pin lock mechanism of claim 1, further comprising a handle attached to the main pin beyond the outer plate.

6. The trailer hitch spring pin lock mechanism of claim 5, wherein the handle is formed by an aperture formed through an outer end of the main pin and a ring disposed within the aperture.

7. The trailer hitch spring pin lock mechanism of claim 1, wherein the protrusion comprises a roll pin snuggly secured within an aperture formed through the main pin.

8. The trailer hitch spring pin lock mechanism of claim 1, wherein a chamfer is formed on an inner end of the main pin.

9. The trailer hitch spring pin lock mechanism of claim 1, wherein the outer plate further comprises a lock hole.
